(19) United States
(12) Patent Application Publication
(10) Pub. No.: US 2014/0318350 A1
(43) Pub. Date: Oct. 30, 2014

(54) HUMBUCKER PICKUP DEVICE FOR ACTIVE AND PASSIVE GUITARS

(71) Applicant: Valeriy Vladislavovich Krasnov, Murmansk (RU)

(72) Inventor: Valeriy Vladislavovich Krasnov, Murmansk (RU)

(21) Appl. No.: 14/266,811

(22) Filed: Apr. 30, 2014

Related U.S. Application Data
(60) Provisional application No. 61/817,695, filed on Apr. 30, 2013.

(51) Int. Cl. G10H 3/22

(52) U.S. Cl. CPC G10H 3/22
USPC 84/726

(57) ABSTRACT

A humbucker pickup device for active and passive guitars includes two magnets positioned besides each other, with opposite poles of the magnets facing each other. A first set of pole pieces may be positioned along an outer pole of the first magnet and a second set of pole pieces positioned along an outer pole of the second magnet. Each set of pole pieces may create two narrow and useful magnetic fields to interact with a respective string at two points. The device includes two coils as a matched pair. The device may include a steel plate between the magnets for improving the interaction of the magnetic fields with the string and a preamplifier working in a balanced input mode.

### CROSS-REFERENCE TO RELATED APPLICATION

This application claims the benefit of U.S. provisional application No. 61/817,695, filed Apr. 30, 2013, the contents of which are herein incorporated by reference.

### BACKGROUND OF THE INVENTION

The present invention relates to electromagnetic pickups for guitars and, more particularly, to an improved humbucker device which is particularly useful in guitars with active electronics. The pickup may also be used in traditional passive electric and bass guitars or other stringed musical instruments.

One common and well-known flaw of conventional two-coil humbucker pickups (i.e. conventional humbuckers) is that conventional humbuckers cannot achieve the tonal characteristics in the guitar sound of conventional single-coil pickups. The sound of guitars with single-coil pickups is usually brighter and clearer than that of humbucker guitars. The main reason of that lies in the different widths of the magnetic fields from the pickups applied to the strings.

Conventional single-coil pickups are narrower than the conventional two-coil humbuckers approximately twice the length, due to their single coil and one row of steel pole pieces. The upper end of each pole piece is directed to a respective string. Unlike the wide humbuckers, the single-coil pickups with one row of the pole pieces provide a narrower magnetic field applied only to one point of a vibrating string. Such magnetic fields inhibit the string vibrations to a lesser extent. Thanks to this fact, the single-coil pickups provide enough beautiful natural sound for electric guitars that allows these pickups, despite their pretty bad noise immunity, to compete successfully with the humbuckers. The conventional single coil pickups, besides a coil, often include a single magnet.

In turn, conventional humbuckers also include a single magnet, however, have two coils and two rows of steel pole pieces (see FIG. 1) to provide a magnetic field applied to two points of the string by means of two pole pieces extending closely to this string. But, in fact, there is one general magnetic field including a wide magnetic field within the interval between these points along the string (see FIG. 1B). An affected portion of the string from such a wide magnetic field is significantly larger than that an affected portion of the string for conventional single-coil pickups (see FIG. 2). As a result, the vibrations of steel strings are subjected to a large negative affect because of the wide and forceful magnetic field of the humbuckers.

Ultimately, the conventional humbuckers do not provide a great advantage in sound, as it should be, with picking the vibrations up in the two points of a string. Many useful harmonics of the vibrations are lost or significantly distorted in the output signal of the humbuckers. Because of this flaw common to all conventional humbuckers, they often lose to the single-coil pickups in regards to the clarity and clearness in the sound.

Aspiring to correct the flaw of conventional humbuckers, different companies making guitars and pickups have created various versions of humbuckers. Recently, however, even despite the good noise immunity of the humbuckers, some guitar manufacturers have recognized that conventional guitar pickups, humbuckers and single-coil pickups, are still imperfect from the point of view of modern technologies of sound recording and transfer. In this regard, some companies have developed digital guitars and special pickups for them now. As a rule, such developments include the steps of inserting and mounting special digital guitar processing circuits inside the guitars. These circuits generate one or more digital string signals from analog string signals, format these digital signals and thereby help the guitars with traditional analog output to be also compatible with a digital communication protocol for output digital audio signals. Many guitar musicians prefer to record their guitars within their home studios built on the basis of modern computers. In turn, the traditional method of recording guitars in studios includes microphones and special guitar amplifiers with speaker cabinets that are very inconvenient at home.

Some companies have chosen simpler way to improve conventional analog guitars without any digital circuits or additional complexity inside the guitars. These companies make special humbucker pickup devices including preamplifiers built on well known circuits. By virtue of two differential inputs, a balanced input mode can be provided when the two differential inputs are connected respectively to the two coils of a conventional humbucker. Usually these preamplifiers are mounted into the humbucker case and such humbucker devices are often called active pickups.

Besides the balanced input the differential amplifiers also have an unbalanced output that is convenient for connection with the volume-tone section inside an electric guitar. Such output may be connected to a volume potentiometer or to the switch of pickups depending on the model of the guitar. The differential amplifiers and the balanced input mode are successfully used in various professional audio devices and studio equipment such as microphone preamplifiers, mixer consoles and others, where the balanced input mode provides a full-fledged and noiseless analog audio signal.

However, in regards to guitar pickups, there is a serious problem. All known methods of connecting these pickups to preamplifiers, including the differential amplifiers in the balanced input mode, cause significant difficulties. These difficulties occur, in particular, due to the values of the conventional pickup's electrical parameters such as inductance, resistance and capacitance being too large. There arises a system of a pickup and a preamplifier as a Low-Pass filter (LP filter) having too low a cut-off frequency, about from 300 up to 1000 Hz depending on the pickup model. This is certainly not acceptable for a good guitar sound. Another issue associated with the use of magnets in the conventional pickups is using these pickups in an active mode such as jointly with a preamplifier.

Modern passive pickups include large force magnets which highlights the mentioned flaw of the conventional humbuckers in regards to the losses and distortions in the output signal. Moreover, the differential amplifiers emphasize this flaw even more, when used jointly with the humbuckers especially when the balanced input mode is used. In this case, additional filters or equalizers are needed inside the body of the humbucker or a guitar that complicates the design of pickups and the guitar, but does not provide an increase in benefit for the guitar sound. A similar situation remains also for conventional single-coil pickups despite their narrower magnetic field. It is quite difficult and often impossible to use the differential amplifiers and the balanced input mode directly with the conventional humbuckers.

Therefore the companies specializing in the production of active humbuckers usually use weak magnets and make special coils of copper wire with a small number of turns (less inductance, resistance and capacitance) to increase the cut-off frequency of the said LP filter in the system of a humbucker and its preamplifier. A weak initial signal from such coils and a weak magnet is amplified to the needed value by the preamplifier mounted into the humbucker or a guitar.

Such active pickups, however, have limited use. Despite the amplified signal of these conventional humbuckers, the guitar musicians often do not like their sound and any other sound produced from coils with too small of an amount of number of turns. Such sound is described as plastic, “no brisk”, with the sound not natural enough. Moreover, there is a tendency among guitarists to look for and order special pickups with a larger number of turns in coils than that in conventional coils of the conventional passive pickups, such as roughly 9000 turns. Despite their bad noise immunity these pickups are very popular among guitar players thanks to their rich and saturated sound.

Typical values of the number of turns in conventional (passive) humbuckers for each coil may be 4500 turns (Neck humbucker) and 5000 turns (Bridge humbucker). The difference in the numbers is necessary due to the fact that a conventional humbucker in the Bridge position on a guitar gives a little less output signal than the same humbucker in the Neck position. Therefore, to level the signals of both pickups relative to each other, the coils of the Bridge humbucker have the larger number of turns, i.e. 5000. Single-coil pickups include coils with the number of turns of about 6000 and more, and for certain pickups this number may even be up to 9000 turns and more.

There have been attempts from various inventors and pickup manufacturers to eliminate the flaw common to the conventional humbuckers and to get more uniform harmonic spectrum like that in single-coil pickups. One of the attempts, for example, is the pickup known as a Side-by-side humbucker. This, in fact, is a narrow humbucker having a peculiar sound. The affected portion on a string from the magnetic field of such narrow pickups become, less, but this is only a partial solution of the problem. Two points on the string, from where the vibrations are picked up, are too close to each other and signals from these two points have harmonic spectrums that are too similar. The sound of the Side-by-side humbucker is poorer concerning harmonics than that from a conventional wide humbucker.

Another humbucker version, a Hum-canceller pickup known as double-coil or dual-coil pickup, is compacted into the size of a single coil. It also has two windings for noise immunity as any conventional humbucker, but its windings have one common row of pole pieces. Thus, the useful signal of the Hum-canceller is picked up only from one point on the string as in single-coil pickups.

All the described pickups only come near to conventional single-coil pickups in regards to the width of the magnetic field applied to a string. The most successful of them are the said Hum-cancellers, which pick up the electromagnetic signal from one point on the string (as that in the single-coil pickups). However the sound of the described pickups is not like that of the familiar and popular sound of conventional, wide humbuckers with their signals from the two points on the string.

The differential amplifiers with their balanced input mode significantly highlight any damage or flaw in the harmonic spectrum of the output signal for any conventional guitar pickup with an active mode. And this is so even for the conventional single-coil pickups, for which the width of the magnetic field applied to the string is also not narrow enough to provide the active mode with high quality and efficiency. Probably because of that, some guitar companies began to create complicated designs in direction of digital guitars with special pickups for them. Moreover, the said negative magnetic effect with one pickup is further enhanced with two or more conventional pickups on a guitar, and losses and distortions among harmonics in the guitar output are additionally increased.

As can be seen, there is a need for a humbucker pickup device that may remain the same wide size as a conventional humbucker and with conventional coils that may provide excellent results in sound without the common flaws of the conventional humbuckers. The sound of the device may greatly exceed the sound of the conventional humbuckers and even the single-coil pickups as regards the clarity and clearness. This is especially true when the device may be used in an active mode, in accordance with which the humbucker pickup device may also include a preamplifier connected to its two coils in the balanced input mode. In this regard, it becomes possible to get quite a good sound of a guitar and a quality signal for recording the guitar even by usual home HI-FI preamplifiers and computers without any microphones, special guitar amplifiers and loudspeakers. The creation of digital guitars may not be such a viable solution.

### SUMMARY OF THE INVENTION

In one aspect of the present invention, a humbucker pickup device for active and passive guitars comprises: a first magnet and a second magnet positioned besides the first magnet, wherein opposite poles of the first magnet and the second magnet face each other; and a first set of pole pieces positioned along an outer pole of the first magnet and a second set of pole pieces positioned along an outer pole of the second magnet, wherein the first set of pole pieces creates a narrow and useful first outside magnetic field and the second set of pole pieces creates a narrow and useful second outside magnetic field between an upper end and a lower end of each set of pole pieces, wherein the first set of pole pieces, the second set of pole pieces, the first magnet and the second magnet are positioned within an interval D, wherein the set of pole pieces, the first magnet and the second magnet create a first magnetic field between the first magnet and the first set of pole pieces, a second magnetic field between the second magnet and the second set of pole pieces, and a third wide magnetic field between the first set of pole pieces and the second set of pole pieces.

In another aspect of the present invention, a humbucker pickup device for active and passive guitars comprises: a first magnet and a second magnet positioned besides the first magnet, wherein the opposite poles of the first magnet and the second magnet face each other; a plate positioned between the first magnet and the second magnet, wherein the plate reduces the third wide magnetic field between the set of pole pieces to underneath strings on the guitar; a first set of pole pieces positioned along an outer pole of the first magnet and a second set of pole pieces positioned along an outer pole of the second magnet, wherein the first set of pole pieces creates a narrow and useful first outside magnetic field and the second set of pole pieces creates a narrow and useful second outside magnetic field between an upper end and a lower end of each set of pole pieces, wherein the first set of pole pieces, the second set of pole pieces, the first magnet and the second magnet are positioned within an interval D, wherein the set of pole pieces, the first magnet and the second magnet create a first magnetic field between the first magnet and the first set of pole pieces, a second magnetic field between the second magnet and the second set of pole pieces, and a third wide magnetic field between the first set of pole pieces and the second set of pole pieces; and a first coil and a second coil as a matched pair, wherein the first coil attaches to the first magnet and around the first set of pole pieces and the second coil attaches to the second magnet and around the second set of pole pieces, wherein the interval D is the distance between a center of the first coil and a center of the second coil.

In another aspect of the present invention, a method for improving the narrowing of the magnetic field applied to the strings from a humbucker pickup device comprises: placing at least one humbucker pickup device underneath a set of strings on a stringed instrument, wherein the humbucker pickup device is defined by a first magnet and a second magnet positioned besides the first magnet, wherein opposite poles of the first magnet and the second magnet face each other; and a first set of pole pieces positioned along an outer pole of the first magnet and a second set of pole pieces positioned along an outer pole of the second magnet, wherein each set of pole pieces with one pole piece from each set creates a narrow first outside magnetic field between an upper end and a lower end of a first pole piece, a narrow second outside magnetic field between an upper end and a lower end of a second pole piece; a first coil and a second coil as a matched pair, wherein the first coil attaches to the first magnet and around the first set of pole pieces and the second coil attaches to the second magnet and around the second set of pole pieces, wherein the interval D is the distance between a center of the first coil and a center of the second coil; and generating electromagnetic signals by having the first narrow magnetic field and the second narrow magnetic field interact with the string.

These and other features, aspects and advantages of the present invention will become better understood with reference to the following drawings, description and claims.

### BRIEF DESCRIPTION OF THE DRAWINGS

FIG. 1 is a perspective view of a conventional two-coil humbucker pickup in its assembled configuration (prior art);

FIG. 1A is a perspective view of a magnetic system of the conventional humbucker pickup of FIG. 1 (prior art);

FIG. 1B is an elevation view of the magnetic system of the conventional humbucker pickup of FIG. 1A showing the interaction of the magnetic field with the strings above it (prior art);

FIG. 2 is an elevation view of a magnetic system of a conventional single-coil pickup showing the interaction of the magnetic field with the strings above it (prior art);

FIG. 3A is a perspective view of an exemplary embodiment of the present invention showing a magnetic system of it;

FIG. 3B is an elevation view of an exemplary embodiment of the magnetic system of the humbucker pickup of FIG. 3A showing the interaction of the magnetic field with the strings above it;

FIG. 4A is a perspective view of an alternate embodiment of the present invention showing a magnetic system of it;

FIG. 4B is an elevation view of an alternate embodiment of the magnetic system of the humbucker pickup of FIG. 4A showing the interaction of the magnetic field with the strings above it;

FIG. 5 is an exploded perspective view of structural components including coils of the humbucker pickup of FIGS. 3A and 4A;

FIG. 5A is an elevation view of the humbucker pickup in its assembled configurations for an exemplary embodiment of the present invention;

FIG. 5B is an elevation view of the humbucker pickup in its assembled configurations for an alternate embodiment of the present invention;

FIG. 6 is a schematic wiring diagram showing the presently preferred embodiment of the present invention in the active mode with a preamplifier on a guitar;

FIG. 7 is a schematic wiring diagram of power supply for operational amplifiers of the preamplifier of the humbucker pickup; and

FIG. 8 illustrates a recommended disposition of magnets inside the humbucker pickup relative to the pole pieces associated with the sixth string for a case of the magnets of big force.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a humbucker pickup device for active and passive guitars that may include two magnets positioned besides each other. Opposite poles of the first magnet and the second magnet may face each other and for convenience referred to hereinafter as internal poles of the magnets. For both the active and the passive modes of the invention two coils may be used with, but not limited to, any conventional number of turns. The coils may be substantially identical as a matched pair. A first set of pole pieces may be positioned along an outer pole of the first magnet and a second set of pole pieces may be positioned along an outer pole of the second magnet. The set of pole pieces and the two magnets may create several magnetic fields beneath each string, two of which are uniquely narrow and useful magnetic fields applied to the string. More specifically, each pair of pole pieces of different magnets beneath a respective string may create: a first useful magnetic field between an upper end and a lower end of a pole piece of the first magnet, a second useful magnetic field between an upper end and a lower end of a pole piece of the second magnet. The first magnet and the second magnet may be positioned within an interval D, wherein the same set of pole pieces (beneath the same string) and the internal poles of the magnets may create an additional three magnetic fields: a first magnetic field (not affecting the string) between the upper end of the pole piece of the first magnet and the internal pole of the first magnet, a second magnetic field (not affecting the string) between the upper end of the pole piece of the second magnet and the internal pole of the second magnet, and a third wide magnetic field extending along the string between the upper ends of these pole pieces of the first and second magnets. As a general rule, the internal poles of the magnets positioned within the interval D and far from the string remove all magnetic fields in this interval from a zone of string vibrations down closer to the magnets. Thanks to this, the third wide magnetic field, which may be unwanted, in the interval D extending along the string becomes too weak to affect the string vibrations. Respectively, all frequencies and harmonics of the vibrations with wavelengths and half-waves getting to this interval remain without any losses and distortions. As a result, the humbucker pickup device provides an output signal enriched with new and natural harmonics which is absent in conventional humbuckers and other pickups. This advantage may be particularly noticeable in the active mode with a preamplifier working as a differential amplifier connected to humbucker coils in a balanced input mode.

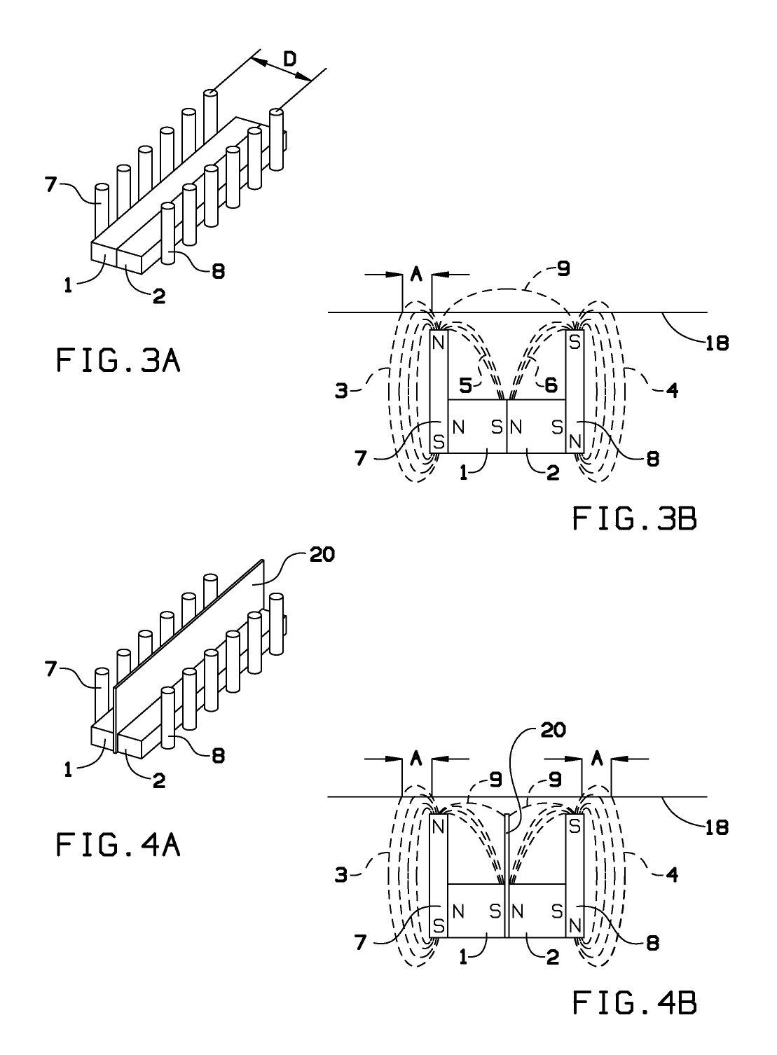

As is illustrated in FIGS. 3A through 8, the humbucker pickup device for passive and active guitars may include a pair of identical transversely polarized permanent magnets 1 and 2 of a certain force. The humbucker pickup device of the present invention may be referred to as the device. Though their forces may be of any amount, they may be substantially equal to each other as well as their geometrical sizes. The magnets 1, 2 may include a first magnet 1 and a second magnet 2 as is shown in FIGS. 3A, 3B, 4A, 4B. The magnets 1, 2 may be of any magnetic material. In certain embodiments, each of the magnets 1, 2 may be a rectangular bar with a cross-section of approximately 7×7 mm and with a length of not less than approximately 50 mm. FIGS. 3A, 3B illustrate an exemplary embodiment of the present invention.

In certain embodiments, a plate 20 may be placed in between the magnets 1, 2 as is shown in FIGS. 4A, 4B. The plate 20 may be made of soft iron, steel, or the like, with a thickness of approximately 0.5-1.0 mm. The plate 20 length may be not less than the length of the magnets 1, 2, and the plate 20 height may be about the same as that for a first set of pole pieces and a second set of pole pieces. Two or more pole pieces 7, 8 may form these different sets beneath a respective string 18 as indicated. The first set of pole pieces and the second set of pole pieces may be positioned along outer poles of the magnets 1, 2 respectively and, also, may be within the distance between a first coil L1 and a second coil L2. The coils L1, L2 are not shown in FIGS. 3A, 3B, 4A and 4B for clarity. All pole pieces may be any type such as poles, bars, screws, studs, or the like and they may be made from soft iron, steel or the like.

As is shown in FIG. 3B, the outer poles of the magnets 1, 2, the opposite N and S, may induce opposite poles on the pole pieces 7, 8. In turn, opposite poles may arise also on the upper and lower ends of each of the pole pieces 7, 8. Under a string 18, the first pole piece 7 may create a first outside magnetic field 3, and the second pole piece 8 may create a second outside magnetic field 4, which may be the main useful magnetic fields interacting with the string 18. These main useful magnetic fields may include the magnetic field 3 between the upper and lower ends of the pole piece 7 and the magnetic field 4 between the upper and lower ends of the pole piece 8. The string 18 may be made of steel or the like.

Further, the pole pieces 7, 8 and the magnets 1, 2 may create an additional three magnetic fields under the same string 18, which may be removed down closer to the magnets 1, 2 within an interval D being the distance between the pole pieces 7, 8 (FIG. 3B). These magnetic fields may include: a first magnetic field 5 between the first magnet 1 and the first pole pieces 7 which may not affect the string 18, a second magnetic field 6 between the second magnet 2 and the second pole pieces 8 which may not affect the string 18, and a third, wide magnetic field 9 extending along the string 18 between the pole pieces 7, 8, which may be unwanted. This wide magnetic field 9 may be a residual and weak magnetic field around the string 18. In the case of a single device on a guitar, this wide magnetic field 9 may be neglected concerning its affect on the string vibrations.

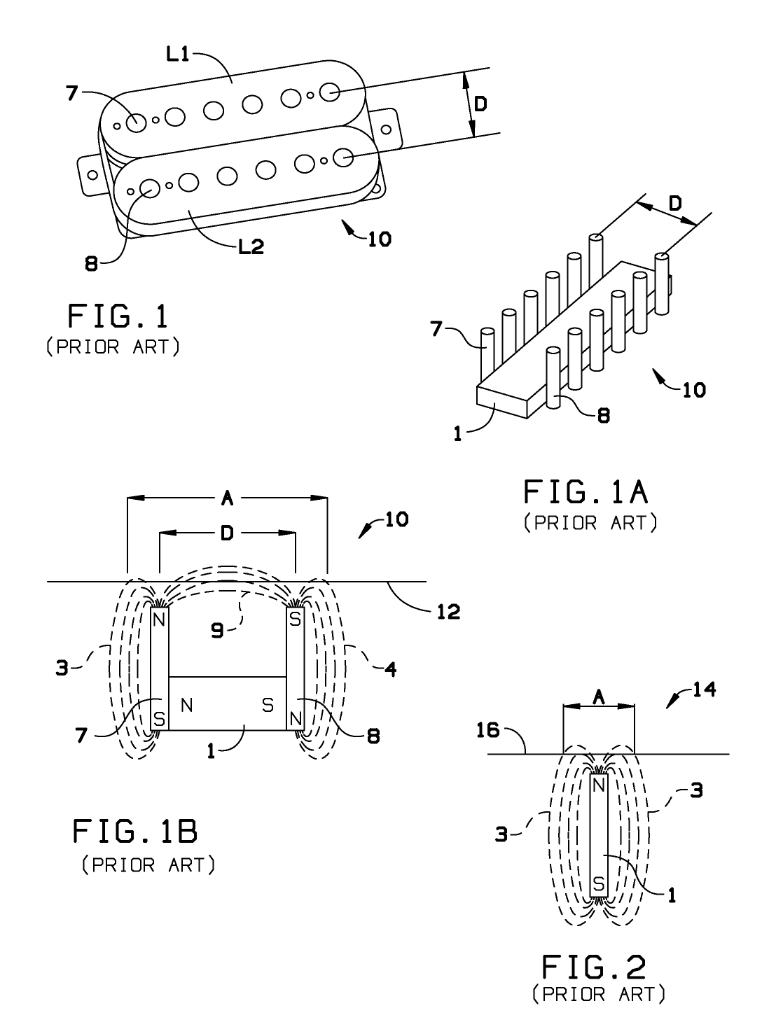

The two magnets 1, 2 may be close, back to back, and mutually attracted to each other due to the opposite poles north N and south S, as shown in FIGS. 3A and 3B. These poles, named as the internal poles of the magnets, may be in the approximate center of the interval D between the first and second sets of pole pieces. The total width of the two magnets 1, 2 of FIG. 3A may be approximately the same as that one of a single magnet 1 of FIG. 1A illustrating a magnetic system of a conventional humbucker 10 (coils are not shown). The magnets 1, 2 may be located in the analogous place between the lower ends of pole pieces of different sets as where the single magnet 1 is positioned in the conventional humbucker 10. Thus, the general dimensions of the humbucker pickup device may be the same as that of any conventional humbucker.

As is shown in FIG. 3B, lines of force 3, 4, 5, 6 and 9 indicate all magnetic fields that may emanate from the upper ends of pole pieces 7 and 8 into both sides, but only the lines of force 3 and 4 (the two useful magnetic fields) may effectively interact with the string 18 without any negative affect on it.

An affected portion A of the string 18 because of one useful magnetic field 3 of the humbucker pickup device is shown in FIG. 3B. As is seen, this portion A may be substantially small. It is much smaller than the interval D between the pole pieces 7, 8 and much smaller than the width of the device having the same conventional coils and pole pieces as in any conventional humbucker 10. Also, this portion A from any of the two magnetic fields 3, 4 may be much smaller than a distance between them, i.e. between the two affected portions A on the string 18 from these fields (see FIG. 4B as for the two portions A and the distance between them). Thereby, a part of the string 18 corresponding to this distance and being in close proximity to the device may be almost completely free in its vibrations from a negative influence of the magnetic fields 3, 4.

In turn, for the conventional humbucker 10 of FIG. 1B with the single magnet 1, an affected portion A on a string 12 from all magnetic fields 3, 4 and 9 is much more than that of one device such as shown in FIG. 3B. The wide magnetic field 9 of the conventional humbucker 10, FIG. 1B, is too large of a field for the force and it cannot be neglected. In fact, in this case the affected portion A of a string 12 is commensurate with the interval D and the width of the humbucker 10.

Also, in the case of the humbucker pickup device of FIG. 3B, the small affected portion A on the string 18 may be even smaller (more than twice) than that on a string 16 for a single-coil pickup 14 of FIG. 2 with a single set of pole pieces (a coil not shown). In particular, FIG. 2 illustrates a version of the single-coil pickup 14 with a single continuous magnet 1 instead of sets of pole pieces 7, 8.

In other words, from FIG. 3B, the width or the magnetic field aperture A applied to the string 18 belongs only to one branch, the first outside magnetic field 3, of magnetic fields emanating from the upper end of the pole piece 7. This effective aperture A may be outside of the interval D, and may be uniquely small and quite harmless to the string 18, such as a steel string or the like, not hampering its vibrations. While another first magnetic field 5 emanating from the same pole piece 7, within the interval D, may be displaced down further from the string 18. The first magnetic field 5 and second magnetic field 6 emanating from the pole pieces 7, 8 may not interact with the string 18 throughout the interval D, which is a contrast from what occurs in the conventional humbucker 10 of FIG. 1B, where in the same interval a wide magnetic field 9 is, in fact, the main magnetic field in generating the electromagnetic signals. In the conventional single-coil pickup 14 of FIG. 2, an aperture A is formed from two branches of the magnetic field 3.

The uniquely small apertures A of the magnetic fields 3, 4 (FIGS. 3B, 4B) results in the fact that string vibrations occur without any hindrance from these fields, without any losses or distortions in the frequency spectrum, and, in fact, with new harmonics for the humbucker pickup device.

It is possible to estimate approximately a profit from such small aperture A for the harmonic spectrum of the invention output in comparison with the conventional humbucker 10 and the single-coil pickup 14. For convenience it is possible to consider that along the string 12 an aperture A of FIG. 1B (the conventional humbucker 10) is approximately equal to the interval D that for conventional humbuckers 10 is equal usually about 18 mm (though, the aperture along the string 12 may be a little more). Further also approximately, an aperture A of FIG. 2 (the single-coil pickup) is twice lesser than the interval D of FIG. 1B, i.e. 18/2=9 mm. And the smallest aperture A of FIG. 3B (the present device) may be twice as less than that one of FIG. 2, i.e. 9/2=4.5 mm. Knowing the length of a vibrating string on a guitar (about 648 mm) and based on standard calculations of physics of vibrating string it is possible to determine frequencies, wave-lengths of which (or half wave-length) become comparable with the said apertures. For example, for the sixth string, a note E (mi, 80 Hz), the said calculations may show that the values of the apertures 18, 9 and 4.5 mm correspond to harmonics with frequencies 2880 Hz, 5760 Hz and 11360 Hz. This means that losses and distortions into the harmonic spectrum for the conventional humbucker 10 of FIG. 1B may be already for frequencies from 2880 Hz and above, for the single-coil pickup, respectively, from 5760 Hz, that is better, and for the device from approximately 11360 Hz, i.e. the best result.

Indeed, conventional humbuckers have a well-known failure around 3000 Hz into their amplitude-frequency characteristic for the sixth string. Frequencies around 3000 Hz are the same frequencies that provide the brightness and clarity in the guitar sound and what usually does not suffice with conventional humbuckers 10.

The best result from the calculations means that the frequency range of the device may be without any losses and distortions in fields up to approximately 11360 Hz. This is a very good result because for any guitar and guitar equipment a working range up to approximately 10000 Hz may be acceptable. This is, of course, an approximate result, but real proportions in the magnetic field apertures of the described pickups may be even better for the humbucker device (and worse for the conventional humbucker 10) than it was accepted in the calculations.

At the same time, despite the narrowing of the useful magnetic fields in the humbucker pickup and their uniquely small apertures A, the humbucker pickup output may not be less than that one for a conventional humbucker 10 with the same coils and a single magnet. I.e., the humbucker pickup may well be used in a usual passive version without any preamplifier inside the humbucker device or a guitar. In this case a first coil L1 and a second coil L2, if they are wound in the same direction, may be connected out of phase to each other (this case is not shown). The coils L1, L2 may have opposite magnetic polarities from the sets with pole pieces 7 and 8 (see FIGS. 3B, 4B), as a result, also in opposite electrical polarities the coils may provide noiseless signal as that in any conventional humbucker 10.

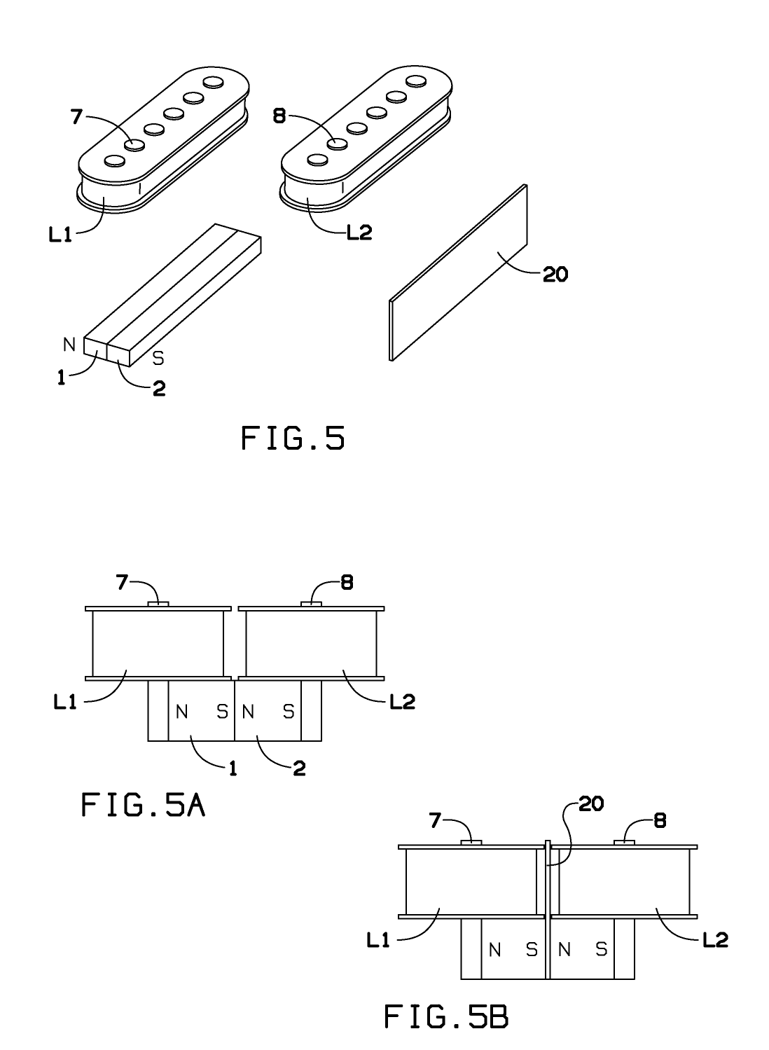

As mentioned, the total width of the two magnets 1, 2 (abutting each other) in the device may be approximately the same as the width of a single magnet 1 in the conventional humbucker 10. It may be desirable to fit the magnets 1,2 into the space between the two sets of pole pieces of the different coils L1,L2 (as the single magnet in conventional humbuckers 10). Owing to this, and using conventional coils L1,L2, the manufacturing technology surrounding the humbucker of the invention may allow for a similar process as with any conventional humbucker 10, thereby decreasing costs. Improving the conventional humbucker 10 may also be possible by replacing the single magnet by the two magnets 1, 2. FIGS. 5, 5A, 5B, illustrate components of the present invention (with conventional coils L1, L2) in their separated and assembled configurations for the two embodiments of the invention.

However, to get the full benefit in the guitar sound from the humbucker output enriched by the new harmonics and to use some other possibilities of the present invention, the active mode with a preamplifier may be preferred. The conventional coils L1, L2, which may have any number of turns and the magnets 1, 2 of any force, may give the present invention a big advantage in the manufacturing technology in comparison with traditional active pickups.

In substance, an important advantage of the present invention may be its ability to be effective and convenient if it is used with a preamplifier which can work in the balanced input mode, i.e. as a differential amplifier. Usually differential amplifiers are built from operational amplifiers by well known circuits and successfully used, in professional audio and studio equipment. In certain embodiments, the preamplifier for the invention as a differential amplifier may be built from one or more operational amplifiers.

An electric guitar with the humbucker device in the active mode may provide an excellent sound with natural middle frequencies and without any surplus in the low frequencies, i.e., provides an excellent balance of frequencies. This guitar sound may be quite natural, with the present invention it may be achieved easily without any additional filters or equalizers inside the guitar which are often used in cases of conventional active pickups, active and digital guitars. The sound of the humbucker with the active mode may greatly exceed the sound of conventional (passive) humbuckers 10 and even single-coil pickups on the same guitar or any other as regards to the clarity and clearness, and may be more saturated and beautiful.

The Preamplifier and the Active Mode

In particular, a preamplifier for the present invention may be built from two or three operational amplifiers and be used as one of the improved differential amplifiers known as instrumentation amplifiers. One of their useful features is the fact that they have excellent high input impedance that may be useful for the invention to get the full benefit from the humbucker output enriched by the new harmonics.

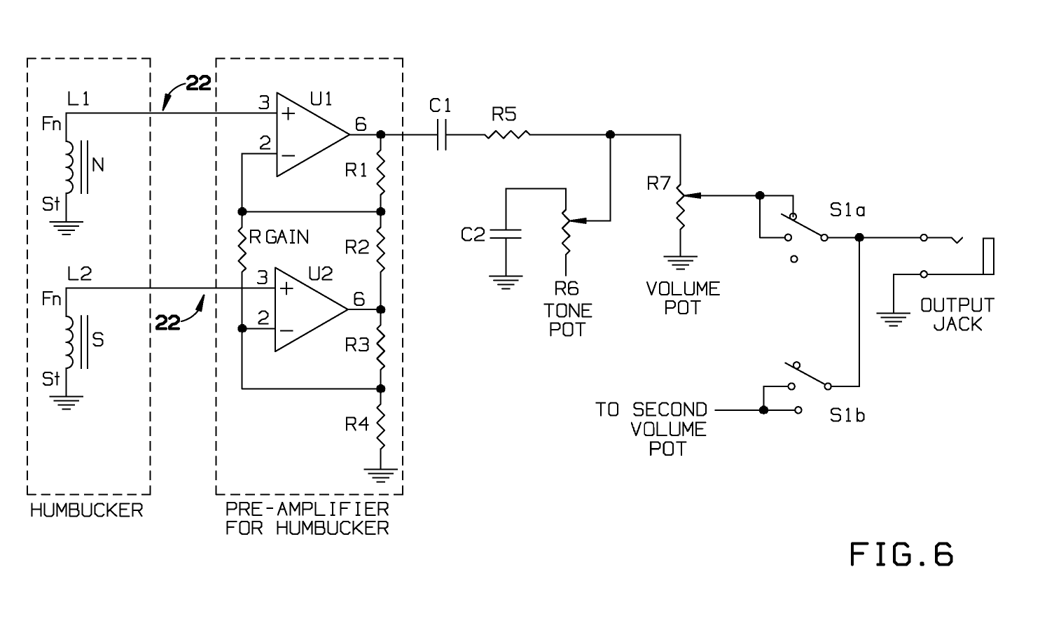

FIG. 6 illustrates a preferred embodiment of the present invention with a preamplifier built from two operational amplifiers U1 and U2. As is seen, the preamplifier may be connected to two coils L1 and L2 of the humbucker pickup in the balanced input mode by two differential inputs 22 (the balanced input). In certain embodiments, the coils L1,L2 may be wound in the same direction to get the balanced input mode. Each of the inputs 22 may be connected to the end of a respective coil, and the beginnings of both coils may be grounded. The two coils L1 and L2 may have opposite magnetic polarities due to opposite poles of the pole pieces 7 and 8 (see FIGS. 3B, 4B) belonging to the different coils L1 and L2 (not shown in those Figures). Thus, two signals from the coils L1,L2 may be electrically of opposite polarities as well. The preamplifier may work in such a way that further, one of the signals (from the coil L2) may be inverted by inverting input 22 of the operational amplifier U1, shown in FIG. 6. Both useful signals may be added, and the noise, which may be electrically induced in the coils L1,L2, may cancel each other out.

In FIG. 6 the embodiment with the preamplifier is shown with an electric guitar including two pickups with respective two volume and two tone potentiometers and a typical 3-way switch S1 of the pickups. Inside the guitar body the unbalanced, usual output of the preamplifier may be connected to a volume potentiometer R7 through a capacitor C1 and a resistor R5. The resistor R5 may be used when mixing the signals with two or more active pickups on the guitar.

In certain embodiments, two devices may be used on a guitar and if both are in the active mode, then a second device may have a second preamplifier of its own. Both devices and their preamplifiers may be identical. Therefore, the second device and its preamplifier are not shown. Accordingly, the output of the second preamplifier may be connected to a second volume potentiometer of the guitar in the same manner (through a capacitor and a resistor identical to C1 and R5) as in FIG. 6 for the first preamplifier. A difference may be be in resistors R-GAIN of the preamplifiers, by means of which the desired output level may be set for each device on the guitar. An amplification factor or the gain for the preamplifiers may be within 2-3, which may allow the corresponding output signal of the electric guitar to be compatible with conventional guitar equipment such as amplifiers, effect boxes and the like.

Concerning the resistors R-GAIN, they may allow the gain of the preamplifier's output signal to be changed by changing the value of a single resistor in the preamplifier circuit. This may be convenient for any guitar if it comprises two (and more) the present invention because here there may be no need to follow the strict proportion to the number of turns between the Neck and Bridge pickups as that in conventional passive pickups. For example, with identical resistors R1=R2=R3=R4 and equaling 15K, at first in a Neck humbucker's preamplifier the resistor R-GAIN may be set and fixed within from 300K to 500K, or the resistor may not be. Next, in a Bridge humbucker's preamplifier, the analogous resistor R-GAIN may be chosen from approximately 33K to 47K or the like, to adjust and fix the outputs of both humbucker devices in accordance with each other.

Also, the resistor R-GAIN gives the chance to add in parallel to it an additional resistor to increase the gain and the level of the guitar output. This may be useful benefit in home studios when the special equipment of studio or for guitar may be absent or inconvenient, and the usual output level of an electric guitar may be insufficient to record in a home studio computer-based environment. In this case, the electric guitar body may comprise an additional 2-way toggle connecting (or disconnecting) the additional resistor to provide for the guitar an additional gain, such as an additional mode of work, for example, with the usual home HI-FI preamplifiers and others.

Referring back to the prior art, FIG. 1B, it can be noted that for the conventional humbucker 10 with its flaw (as regards to the losses and distortions in its harmonic spectrum), the instrumentation amplifiers with their excellent high input impedance, emphasizes this flaw even more, thereby, making the conventional humbucker 10 use almost impossible here. Then in case of the present invention (in the absence of the flaw), vice versa, these amplifiers (including the preamplifier of FIG. 6 built from U1, U2) highlight an excellent frequency balance and saturation of the guitar sound including new useful (natural) harmonics which is very well heard. Thanks to this, the guitar sound may become quite musical and this is so, even when an electric guitar may not be of the best quality. The balanced input mode of the preamplifier of FIG. 6 may provide the same benefits as that in any other studio equipment from similar preamplifiers working in the same balanced mode. Such benefit is completely impossible with the conventional humbucker 10 because of its flaw, also impossible in digital guitars which may comprise conventional magnetic pickups with the same flaw and require additional filtering circuits and equalizers inside the guitar body, and also, an additional digital output on the guitars.

A guitar (electric, bass or other) with the device and its preamplifier may also be compatible with different amplifying equipment not associated with electric guitars. In this way, the guitar may provide an excellent full-fledged signal for recording even by means of usual home HI-FI preamplifiers in home studios computer-based, wherein special guitar amplifiers with loudspeakers and microphones are inconvenient. Therefore, any analog-digital conversion inside a guitar may not be required and the problem of creating digital guitars may not be as big of a problem for manufacturers.

The Components for the Preamplifier

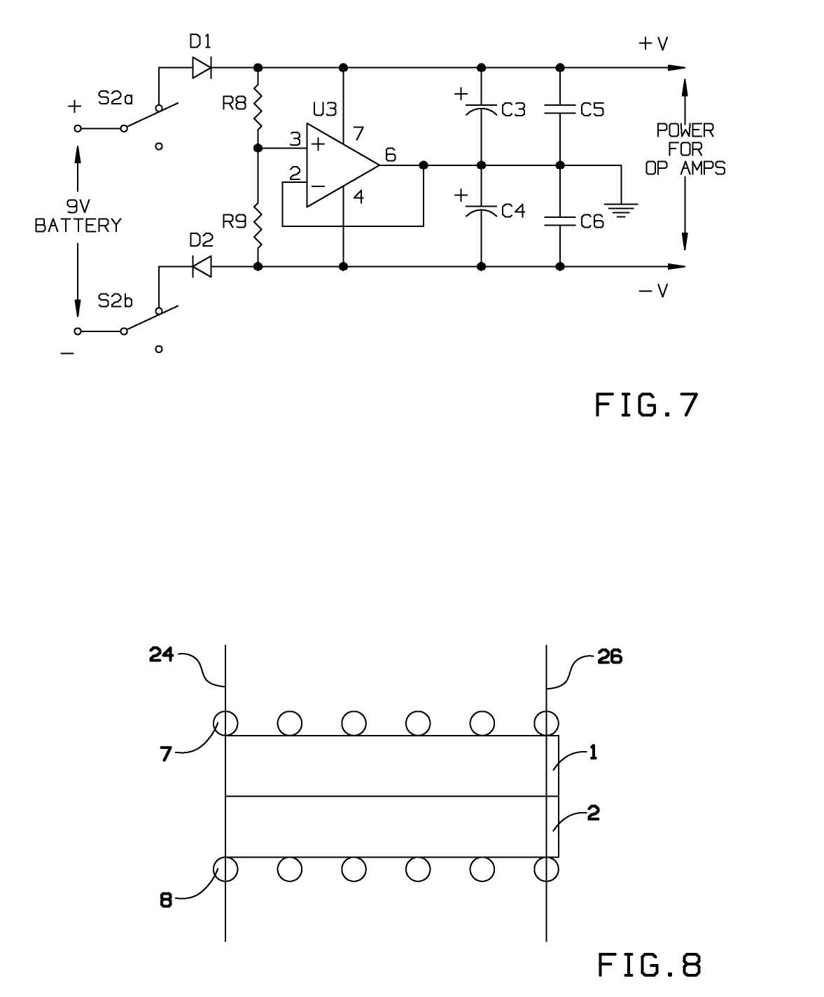

The preamplifier of FIG. 6 and its power supply may be built from operational amplifiers TL061 as U1, U2 and U3 (see also FIG. 7). TL062 (taking into account other leads in the chip) and other operational amplifiers, such as any conventional amplifiers used in audio devices, such as ones with a low current supply of approximately less than 3.0 mA. Resistors R1, R2, R3 and R4 may be identical and equaling within from approximately 10 k up to approximately 20 k. Resistor R5 may be from approximately 3.3 k to approximately 5.6 k, the capacitor C1 may be within from approximately 0.22 uF to approximately 1.0 uF. With the active mode, volume potentiometers on guitar (R7 in FIG. 6) may be roughly 250 k and less.

FIG. 7 illustrates a bipolar power supply circuit as one of a possible power supply for the preamplifier. Using an operational amplifier U3 with diodes D1, D2 the power supply may provide power by switching on/off the power by a 2-way toggle S2. Sometimes for switching on/off the power there may be used an output stereo jack on active guitars. Here, the toggle S2 may be used as an additional toggle on a guitar. It allows for the guitar to use a standard output mono jack. Also, thanks to the bipolar circuit and the diodes D1 and D2 the toggle S2 may provide almost noiseless switching on/off the power. At the same time, the diodes may protect the preamplifier from the incorrect reverse polarity from the battery. The diodes D1, D2 may be 1N4148, 1N4150 and the like. Resistors R8, R9 may be from approximately 200 k to approximately 240 k, oxide capacitors C3, C4 from approximately 6.8 uF to approximately 10 uF, capacitors C5, C6 from approximately 0.05 uF to approximately 0.1 uF. One or two preamplifiers on a guitar may require power supply from a single 9 Volt battery as it is in any active or digital guitar.

The preamplifier of the device may be mounted inside an electric guitar into the Volume-Tone section or directly inside the device like EMG pickups or the like.

A Guitar and the Alternate Embodiment with the Plate

Though the exemplary and the alternate embodiments of the present invention give similar tones in the guitar sound and both tones equally beautiful, it may be very useful for an electric guitar when at least one of its pickups is of the alternative version of the present invention with the steel plate 20, as shown in FIGS. 4A, 4B. This may be due to a known defect in the guitar sound arising from mixing the two signals from two conventional humbuckers 10 on a guitar similar to the humbucker 10 of FIG. 1 when in the guitar output there is a mixed signal. At the time of switching on both humbuckers 10, this defect may manifest as an obvious loss of the brightness and the clarity in the sound, a characteristic sharp failure in the middle frequencies at the time of the switching. This occurs because of accumulating (doubling) the flaw of the conventional humbucker 10 described above by FIG. 1B. In the mixed mode, frequency losses and distortions in the guitar sound become even more noticeable. In practice, when both conventional humbuckers 10 are switched on simultaneously, guitar players are often forced to make an additional adjustment by means of guitar potentiometers to catch a good sound, and some players may not use this mixed mode. In the case when at least one of two humbuckers on the guitar is of the alternative version of the present invention, the said accumulation does not occur and the described sound defect is absent.

Some failure in the brightness of the guitar sound may be slightly noticeable in the mixed mode with two devices as shown in FIG. 3B. Some negative effect from the residual wide magnetic field 9 (see FIG. 3B) may be accumulated and manifested in the sound. While the combination from the two different embodiments, provides an excellent result without any noticeable losses in the blended guitar sound.

The plate 20 may be inserted between the attracted magnets 1, 2 separating them throughout all their length, FIG. 4A. The plate 20 may extend to the guitar strings 18 at the same distance as the pole pieces 7, 8. The plate 20 may act as a shield against the undesirable wide magnetic field 9, shown in FIG. 4B. Also, the plate 20 may act as a third auxiliary pole piece inside the interval D. However, a magnetic force of this plate 20 disposed between the two attracted magnets 1, 2 may be very weak in contrast to magnetic forces of the pole pieces 7, 8. Being a weak pole, the plate 20 may not interact with the guitar strings 18 and does not affect the other two magnetic fields 5, 6 inside the interval D. However, the small magnetic force of the plate 20 may be quite sufficient to eliminate small remains of the unwanted wide magnetic field 9 around the string 18 if the plate 20 extends also close to the string as the pole pieces 7 and 8. Then the wide magnetic field 9 may be captured down closer to the plate 20 and be outside the vibrations of the guitar string 18, as shown in FIG. 4B.

Thus, the alternate embodiment of the present invention with the plate 20 may be completely free from that flaw common to the all conventional humbuckers 10 and with this version any accumulation of losses or distortions do not happen in the blended sound. Therefore, in certain embodiments, to avoid the accumulation, the device as shown in FIG. 4B, may be used with a conventional humbucker 10 of FIG. 1B on one guitar. As for the Neck or Bridge positions on the guitar where pickups are set, at least the device as shown in FIG. 4B may be used in one any of these pickup locations: either the Neck or the Bridge. In both cases the guitar sound from mixing the pickups may be full with less loss.

Though a more interesting benefit may be achieved when the two various embodiments of the present invention are used on one guitar in locations: one device in the Neck and another device in the Bridge, especially when both humbucker devices work in the active mode with their respective preamplifiers. Here, the blended sound may turn out as a new guitar sound with its own enriched tone that appears at once at the time of switching to the blended sound without any additional adjustment of guitar potentiometers. In this regard, the two devices of the various embodiments (one of them with the plate 20) may be particularly useful as a kit-pair of the devices for two-pickup guitars.

Another interesting benefit from the at least two various embodiments of the present invention may be achieved in electric guitars intended for three pickups, in particular, three humbuckers. Now three-humbucker guitars are even less spread on the market than two-humbucker guitars because of the said defect in the guitar sound from the mixed mode which is increased from three conventional humbuckers 10 on a guitar, and the degradation of the guitar sound becomes even more noticeable. Therefore, the mixed mode from three conventional humbuckers 10 is usually not used. A third conventional humbucker in those three-humbucker guitars is positioned in a Middle location between the Neck and the Bridge humbuckers. And in the mixed mode it is connected alternatively either to the Neck humbucker or to the Bridge, or other variants, but not all three humbuckers together.

Generally, a characteristic feature of the mixed mode is the fact that with the addition of each of the following conventional humbuckers 10, the guitar sound may steadily be degraded. In turn, for the humbuckers of the present invention, the opposite may be true, in mixed mode the sound becomes fuller and saturated, approaching to the sound of an acoustic guitar with adding signals from the different devices and, accordingly, from various points of the string. The benefit for the sound from the different pickup-positions is the fullest and all three devices may be used for mixing to get a sound similar the acoustic guitar sound.

In certain embodiments, for three-humbucker guitars it may be recommended to have three devices, one of which may be of the exemplary embodiment without the plate (see FIG. 3A), and two other of the alternate embodiment with the plate 20 (see FIG. 4A).

### Other Alternate Embodiments

If the poles of the magnets are in reverse order, vice versa, the effect of the invention may be the same. There may be additional manners of balanced connection between the coils and the preamplifier: with a single polar power supply for operational amplifiers and a balanced connection without the mid-point (the coils may not be connected to the ground on any side). In these cases the effect of the invention may be almost the same. In an alternate embodiment additional good guitar sounds may be obtained if the coils of the device may be connected together in the usual humbucker manner and, may be connected only to one of the preamplifier inputs, and the second input may be grounded.

For fans of pickups with the increased number of windings, of about 9000 and more, a similar sound may be obtained by means of the device and coils L1, L2 with an increased number of windings (from approximately 5000 and more for each coil). The device may not repeat fully a single-coil pickup 14 in sound because it picks up the string vibrations at the two points, however because of this, its tone may be even more beautiful and saturated. In the case of large force magnets, a small excess of low frequencies may be possible from the sixth string 24 of the guitar. To avoid this, FIG. 8 illustrates a recommended disposition of the magnets 1, 2 in the device relative to pole pieces pertaining to the sixth string 24 especially in the case of large force magnets. The length of the sides of both magnets 1, 2 may be shortened. In certain embodiments, the length of the pole pieces 7, 8 under the sixth string 24 may also be shortened.

In certain embodiments, the invention may be used where narrowly directed magnetic fields are needed. In particular, it may be possible to improve the direction and focus of the magnetic field to the string vibrations in single-coil pickups. After that, the use of differential amplifiers in guitars with these pickups may become much easier to obtain a good sound and signal for recording.

There are many electric guitars made of expensive types of wood. Practical use of the device has shown that cheap guitars made of cheap wood and even guitars not made of wood, for example, the pressed cardboard or plastic and the like, also have a quality sound. The difference in the sound between expensive guitars made of expensive wood and cheap guitars of cheap wood becomes much less if these guitars have the invention. This will allow guitar companies to reduce the use of expensive wood without loss of the sound quality in the guitars.

It should be understood, of course, that the foregoing relates to exemplary embodiments of the invention and that modifications may be made without departing from the spirit and scope of the invention as set forth in the following claims.

What is claimed is:

1. A humbucker pickup device for active and passive guitars comprising:
a first magnet and a second magnet positioned besides the first magnet, wherein opposite poles of the first magnet and the second magnet face each other; and
a first set of pole pieces positioned along an outer pole of the first magnet and a second set of pole pieces positioned along an outer pole of the second magnet, wherein the first set of pole pieces creates a narrow and useful first outside magnetic field and the second set of pole pieces creates a narrow and useful second outside magnetic field between an upper end and a lower end of each set of pole pieces, wherein the first set of pole pieces, the second set of pole pieces, the first magnet and the second magnet are positioned within an interval D, wherein the set of pole pieces, the first magnet and the second magnet create a first magnetic field between the first magnet and the first set of pole pieces, a second magnetic field between the second magnet and the second set of pole pieces, and a third wide magnetic field between the first set of pole pieces and the second set of pole pieces.

2. The humbucker pickup device in claim 1, wherein the first magnet and the second magnet are rectangular in shape, wherein forces of the first magnet and the second magnet are substantially equal to each other.

3. The humbucker pickup device in claim 1, further comprising a first coil and a second coil as a matched pair, wherein the first coil attaches to the first magnet and around the first set of pole pieces and the second coil attaches to the second magnet and around the second set of pole pieces, wherein the interval D is the distance between a center of the first coil and a center of the second coil.

4. The humbucker pickup device in claim 3, wherein the first coil and the second coil are substantially identical in the number of turns and the electrical impedances.

5. The humbucker pickup device of claim 3, further comprising a preamplifier built from two operational amplifiers creating a differential amplifier, wherein the two operational amplifiers have a balanced input mode from the connection with the first coil and the second coil.

6. A humbucker pickup device for active and passive guitars comprising:
a first magnet and a second magnet positioned besides the first magnet, wherein the opposite poles of the first magnet and the second magnet face each other;
a plate positioned between the first magnet and the second magnet, wherein the plate reduces the third wide magnetic field between the set of pole pieces to underneath strings on the guitar;
a first set of pole pieces positioned along an outer pole of the first magnet and a second set of pole pieces positioned along an outer pole of the second magnet, wherein the first set of pole pieces creates a narrow and useful first outside magnetic field and the second set of pole pieces creates a narrow and useful second outside magnetic field between an upper end and a lower end of each set of pole pieces, wherein the first set of pole pieces, the second set of pole pieces, the first magnet and the second magnet are positioned within an interval D, wherein the set of pole pieces, the first magnet and the second magnet create a first magnetic field between the first magnet and the first set of pole pieces, a second magnetic field between the second magnet and the second set of pole pieces, and a third wide magnetic field between the first set of pole pieces and the second set of pole pieces; and
a first coil and a second coil as a matched pair, wherein the first coil attaches to the first magnet and around the first set of pole pieces and the second coil attaches to the second magnet and around the second set of pole pieces, wherein the interval D is the distance between a center of the first coil and a center of the second coil.

7. The humbucker pickup device of claim 6, further comprising a preamplifier built from two operational amplifiers creating a differential amplifier, wherein the two operational amplifiers have a balanced input mode from the connection with the first coil and the second coil.

8. The humbucker pickup device of claim 6, wherein the first set of pole pieces, the second set of pole pieces, and the plate are made from a ferromagnetic material.

9. A method for improving the narrowing of the magnetic field applied to the strings from a humbucker pickup device comprising:
placing at least one humbucker pickup device underneath a set of strings on a stringed instrument, wherein the humbucker pickup device is defined by a first magnet and a second magnet positioned besides the first magnet, wherein opposite poles of the first magnet and the second magnet face each other; and a first set of pole pieces positioned along an outer pole of the first magnet and a second set of pole pieces positioned along an outer pole of the second magnet, wherein each set of pole pieces with one pole piece from each set creates a narrow first outside magnetic field between an upper end and a lower end of a first pole piece, a narrow second outside magnetic field between an upper end and a lower end of a second pole piece; a first coil and a second coil as a matched pair, wherein the first coil attaches to the first magnet and around the first set of pole pieces and the second coil attaches to the second magnet and around the second set of pole pieces, wherein the interval D is the distance between a center of the first coil and a center of the second coil; and
generating electromagnetic signals by having the first narrow magnetic field and the second narrow magnetic field interact with the string.

10. The method of claim 9, wherein the first magnet and the second magnet of the at least one humbucker pickup device are rectangular in shape, wherein forces of the first magnet and the second magnet are substantially equal to each other.

11. The method of claim 9, wherein the at least one humbucker pickup device further comprises a plate positioned between the first magnet and the second magnet, wherein the plate extends out approximately the same length out from the first magnet and the second magnet as the first set of pole pieces and the second set of pole pieces.

12. The method of claim 9, wherein the at least one humbucker pickup device further comprises two operational amplifiers creating a differential amplifier, wherein the two operational amplifiers have a balanced input mode from the connection with the first coil and the second coil.

13. The method of claim 9, wherein the at least one humbucker pickup device comprises two humbucker pickup devices, wherein one humbucker pickup device further comprise a plate positioned between the first magnet and the second magnet, wherein the plate extends out approximately the same length out from the first magnet and the second magnet as the first set of pole pieces and the second set of pole pieces.

14. The method of claim 9, wherein the at least one humbucker pickup device comprises three humbucker pickup devices, wherein two humbucker pickup devices further comprise a plate positioned between the first magnet and the second magnet, wherein the plate extends out approximately the same length out from the first magnet and the second magnet as the first set of pole pieces and the second set of pole pieces.
